(19) United States
(12) Patent Application Publication
(10) Pub. No.: US 2024/0181420 A1
(43) Pub. Date: Jun. 6, 2024

(54) APPARATUS FOR PYROLYSIS OF ORGANIC WASTES

(71) Applicant: Holland Global International Limited, Road Town Tortola (VI)

(72) Inventors: ZHONG WANG, HONG KONG (CN); JIANJIAN QIN, HONG KONG (CN)

(21) Appl. No.: 18/517,177

(22) Filed: Nov. 22, 2023

(30) Foreign Application Priority Data
Dec. 2, 2022 (HK) 22022065048.9

(51) Int. Cl. B01J 19/00; B01J 4/00; C10B 53/07

(52) U.S. Cl. CPC B01J 19/0053; B01J 4/007; C10B 53/07

(57) ABSTRACT

An apparatus for pyrolysis of organic wastes includes: a feeding mechanism, a pyrolysis reaction mechanism, a carbon black slagging mechanism, a cyclone vacuum cleaner, a catalytic converter, a gas treatment mechanism 6 and a crude oil pump. The two said feeding mechanisms are both connected to the pyrolysis reaction mechanism, the carbon black slagging mechanism is connected to under a right end of the pyrolysis reaction mechanism via a pipeline, the cyclone vacuum cleaner is arranged at an upper end of the pyrolysis reaction mechanism, two said catalytic converters are connected at a top end of the cyclone vacuum cleaner via a pipeline, the gas treatment mechanism is connected to a high end of the catalytic converter via a pipeline, and the crude oil pump is connected to a lower end of the gas treatment mechanism via a pipeline.

### TECHNICAL FIELD

The present disclosure relates to the technical field of oil product treatments, and in particular, relates to a novel process-based apparatus for pyrolysis of organic wastes.

### BACKGROUND

In the production process of modern enterprises, some organic wastes are often generated. If not properly treated, these organic wastes will cause environmental pollution. In addition, the organic wastes can be, by treatment, converted into energy for reuse.

Most of the small-sized treatment apparatuses in the related art basically use small-sized reaction kettles. For example, the apparatus of Chinese Patent No. ZL202123162629.0 includes a feeding mechanism, a pyrolysis reaction mechanism, a pyrolysis slagging mechanism, a slag storage mechanism, a gas treatment mechanism, and an oil treatment mechanism. The feeding mechanism is connected to the pyrolysis reaction mechanism via a pipeline, the pyrolysis reaction mechanism is connected to the pyrolysis slagging mechanism via a pipeline, the pyrolysis slagging mechanism is connected to the slag storage mechanism via a pipeline, and the pyrolysis reaction mechanism; the pyrolysis slag removal mechanism is connected to the gas treatment mechanism via a pipeline, and the gas treatment mechanism is connected to the oil treatment mechanism via a pipeline, and uses a double-kettle reaction, which solves the problems of continuous feeding and high-temperature slag removal. However, it still has some drawbacks: the length of the reaction kettle needs to exceed 6000 mm to allow the reactants to completely react; in addition, an auger shaft of the reaction kettle, an auger and a reamer are welded as a whole, the auger shaft does not bend at all and cannot be fed within one hour before discharging the slag, and in this one hour, the oil in the slag is completely converted, and then the slag is discharged before being fed again, which is not continuous feeding in an absolute sense and the production efficiency is not high.

### SUMMARY

The present disclosure provides a novel process-based apparatus for pyrolysis of organic wastes, including: a feeding mechanism 1, a pyrolysis reaction mechanism 2, a carbon black slagging mechanism 3, a cyclone vacuum cleaner 4, a catalytic converter 5, a gas treatment mechanism 6, and a crude oil pump 7; wherein two said feeding mechanisms 1 are both connected to the pyrolysis reaction mechanism 2, the carbon black slagging mechanism 3 is connected to under a right end of the pyrolysis reaction mechanism 2 via a pipeline, the cyclone vacuum cleaner 4 is arranged at an upper end of the pyrolysis reaction mechanism 2, two said catalytic converters 5 are connected at a top end of the cyclone vacuum cleaner 4 via a pipeline, the gas treatment mechanism 6 is connected to a high end of the catalytic converter 5 via a pipeline, and the crude oil pump 7 is connected to a lower end of the gas treatment mechanism 6 via a pipeline.

Optionally, the gas treatment mechanism 6 includes a first condenser 61, a crude oil tank 62, a second condenser 63, a flammable gas purifier 64, a fuel gas compressor 65, a dehydrator 66, a gas storage capsule 67, and a fuel gas generator set 68; wherein top ends of two reforming catalytic converters 5 are both connected to a top end of the first condenser 61, a bottom end of the first condenser 61 is connected to a top end of the crude oil tank 62, a plurality of said second condensers 63 are connected over the crude oil tank 62 via pipelines, the second condensers 63 are connected via a pipeline, a top end of the second condenser 63 is connected to the flammable gas purifier 64 via a pipeline, a right side of the flammable gas purifier 64 is connected to a top left side of the fuel gas compressor 65, a top right side of the fuel gas condenser 65 is connected to a left lower end of the dehydrator 66, a top end of the dehydrate 66 is connected to the gas storage capsule 67 via a pipeline, and a right side of the gas storage capsule 67 is connected to the fuel gas generator set 68 via a pipeline. The flammable gas purifier 64 is a super-gravity apparatus, which may achieve the effects of dust removal, desulfurization, and dechlorination.

Optionally, a second high-temperature seal valve 51 is arranged on all left pipelines and top pipelines of two reforming catalytic converters 5, and an electromagnetic heater 52 is arranged on both bottom ends of the two reforming catalytic converters 5. The gas treatment mechanism is configured to treat oil and gas discharged from a reaction kettle 21, and decomposed the oil and gas into flammable gas and crude oil. An air outlet of the cyclone vacuum cleaner 4 is connected to the reforming catalytic converter 5 via a flange, a pipeline, and the high-temperature seal valve 51. A filler and catalytic loading port is arranged in the reforming catalytic converter 5. For maintaining temperature of high-temperature oil and gas, the reforming catalytic converter 5 is further provided with an electromagnetic heater 52, and the second high-temperature seal valve 51 connected to the condenser.

Optionally, the feeding mechanism 1 includes a belt conveyor 11, a feeder 12, a plastic extruder 13, and a plastic electromagnetic heater 14; wherein the feeder 12 is arranged under a right end of the belt conveyor 11, the feeder 12 is arranged over a left end of the plastic extruder 13, the plastic electromagnetic heater 14 is arranged on both a middle portion and a right end of the plastic extruder 13, and a right end of the plastic extruder 13 is connected to the reaction kettle 21 via a pipeline. The feeding mechanism 1 is configured to heat materials to a molten state and press the materials into the pyrolysis reaction mechanism 2. During use, the materials are conveyed via the inlet by two belt conveyors 11 upwards to the feeder 12, and then are fed to the plastic extruder 13 via the feeder 12. The materials are then heated by the electromagnetic heater 14 to a molten state, and then fed to the reaction kettle 21 for treatment.

Optionally, the pyrolysis reaction mechanism 2 includes a reaction kettle 21 and a reaction kettle electromagnetic heater 22; wherein a plurality of said reaction kettle electromagnetic heaters 22 are arranged on the reaction kettle 21, a top end of the reactor 21 is connected to the cyclone vacuum cleaner 4 via three pipelines, and a bottom end of the reaction kettle 21 is connected to the carbon black slagging mechanism 3 via a pipeline. The pyrolysis reaction mechanism is configured to react the molten materials. The cyclone vacuum cleaner 4 is configured to remove carbon black brought out by gas and oil. The reaction kettle 21 is designed to have a diameter of 1600 mm and a length of 8500 mm, such that reactants are sufficiently reacted in the reaction kettle 21. The apparatus employs a single reaction kettle system, and achieves a production amount as per day of a double-kettle system. An auger shaft, an auger and a reamer in the reaction kettle 21 are welded as an whole, such that the auger shaft is prevented from bending and deformation. For air tightness of the reaction kettle, flexible high-temperature grease shaft seals are applied to two ends of the auger shaft, a high-temperature seal valve is employed in a high-temperature oil and gas loop, and the carbon black discharging port employs isolation of the carbon black bin.

Optionally, two oil and gas outlets 211 are arranged in a top end of the reaction kettle 21; wherein the oil and gas outlets 211 are connected to left and right sides of the cyclone vacuum cleaner 4 via pipelines, a bottom end of the cyclone vacuum cleaner 4 is connected to the top end of the reaction kettle 21 via a pipeline, and two first high-temperature seal valves 41 are arranged on a pipeline at a bottom end of the cyclone vacuum cleaner 4. An ash discharge port of the cyclone vacuum cleaner 4 is connected to the first high-temperature seal valves 41 via a flange, and the first high-temperature seal valves 41 are connected to a slag return port of the reaction kettle 21 via a flange. Oil and gas discharged from the oil and gas outlets are firstly passed from the cyclone vacuum cleaner, and micro carbon black brought out high-temperature oil and gas are recycled to the reaction kettle.

Optionally, the carbon black slagging mechanism 3 includes a carbon black bin 31, a radar level gauge 32, a water-cooled screw conveyor 33, a carbon black storage bin 34, and a packing screw conveyor 35; wherein a top end of the carbon black bin 31 is connected to a right lower side of the reaction kettle 21, the radar level gauge 32 is arranged on a right side of a top pipeline of the carbon black bin 31, the water-cooled screw conveyor 33 is connected to a bottom end of the carbon black bin 31 via a pipeline, a right side of the water-cooled screw conveyor 33 is connected to a top end of the carbon black storage bin 34, a bottom end of the carbon black storage bin 34 is connected to a left end of the packing screw conveyor 35 via a pipeline, and an outlet 351 is arranged in a right lower side of the packing screw conveyor 35. The carbon black slagging mechanism 3 is configured to store carbon black, and treat and pack the carbon black for sale. The carbon black bin 31 is in cooperation with the radar level gauge 32 to ensure a constant level for the carbon black bin to ensure air tightness (sealing performance) of the reaction kettle.

Optionally, the apparatus is a single reaction kettle system. The reaction kettle has a diameter of 1600 mm and a length of 8500 mm, and thus achieves a production amount as per day of a double-kettle system. The materials have sufficient time for reaction in the reaction kettle, and the production amount reaches the production amount of the double-kettle system.

### BRIEF DESCRIPTION OF THE DRAWINGS

For clearer descriptions of the technical solutions according to the embodiments of the present disclosure or the technical solution in the related art, hereinafter, drawings that are to be referred for description of the embodiments or the related art are briefly described. Apparently, the drawings described hereinafter merely illustrate some embodiments of the present disclosure. Persons of ordinary skill in the art may also derive other drawings based on the drawings described herein without any creative effort.

FIG. 1 is a schematic structural view of an apparatus for pyrolysis of organic wastes according to the present disclosure;

FIG. 2 is a schematic structural view of a feeding mechanism according to the present disclosure;

FIG. 3 is a schematic structural view of a pyrolysis reaction mechanism according to the present disclosure;

FIG. 4 is a schematic structural view of a catalytic converter and a gas treatment mechanism according to the present disclosure;

FIG. 5 is a schematic structural view of a carbon black slagging mechanism according to the present disclosure;

FIG. 6 is a schematic structural view of a cyclone vacuum cleaner according to the present disclosure; and

FIG. 7 is a schematic structural view of an apparatus disclosed by Patent No. ZL202123162629.0.

Reference numbers and denotations thereof: 1—feeding mechanism; 2—pyrolysis reaction mechanism; 3—carbon black slagging mechanism; 4—cyclone vacuum cleaner; 5—catalytic converter; 6—gas treatment mechanism; 7—crude oil pump; 11—belt conveyor; 12—feeder; 13—plastic extruder; 14—plastic electromagnetic heater; 21—reaction kettle; 22—reaction kettle electromagnetic heater; 31—carbon black bin; 32—radar level gauge; 33—water-cooled screw conveyor; 34—carbon black storage bin; 35—packing screw conveyor; 41—first high-temperature seal valve; 51—second high-temperature seal valve; 52—electromagnetic heater; 61—first condenser; 62—crude oil tank; 63—second condenser; 64—flammable gas purifier; 65—gas compressor; 66—dehydrator; 67—gas storage capsule; 68—fuel gas generator set; 211—oi and gas outlet.

### DETAILED DESCRIPTION

In view of the defects and drawbacks of the related art, the present disclosure is intended to provide a novel process-based apparatus for pyrolysis of organic wastes. Based on the apparatus of China Patent No. ZL202123162629.0, the present disclosure devises a single reactor system, which implements continuous feeding, continuous pyrolysis, continuous discharging, effective use of incondensable gas, and energy saving and emission reduction while fully utilizing inherited heat energy to achieve energy saving. The entire system operates under negative micro-pressure, and hazardous gas and dust are effectively controlled, such that generation of hazardous gas dioxin and leakage of dust are prevented, and production sites are maintained clean and tidy.

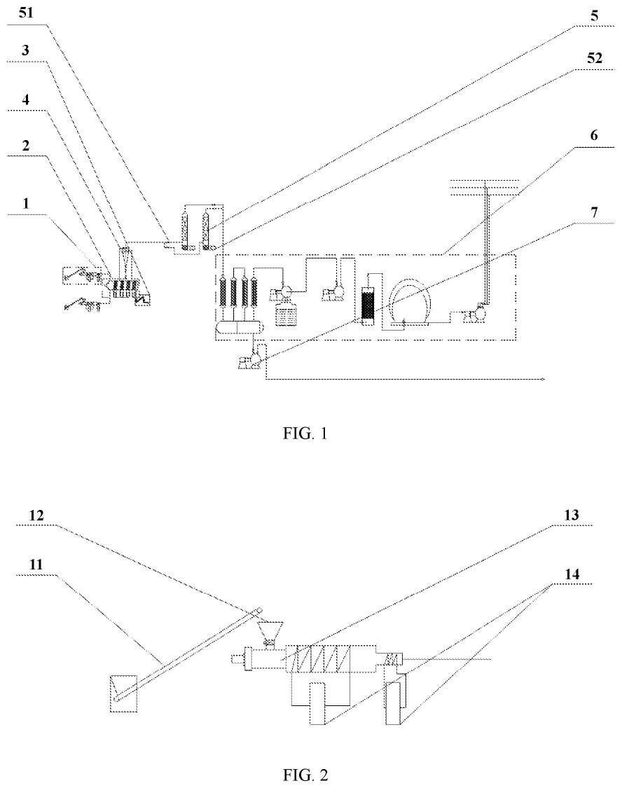

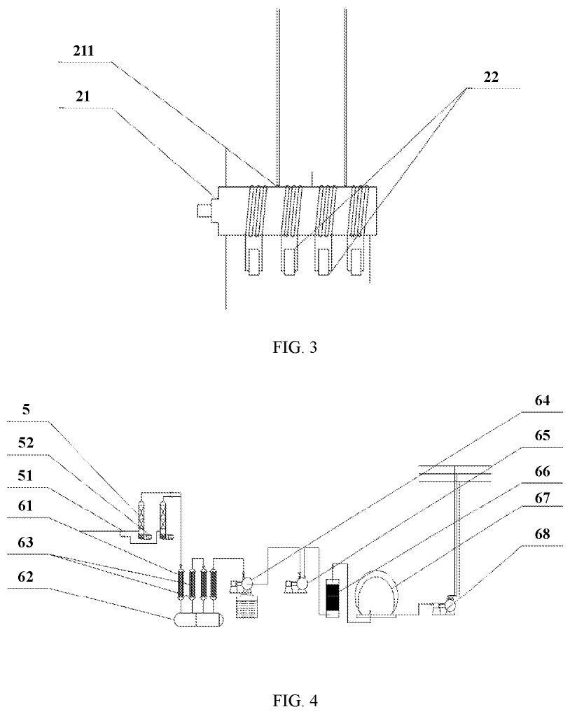

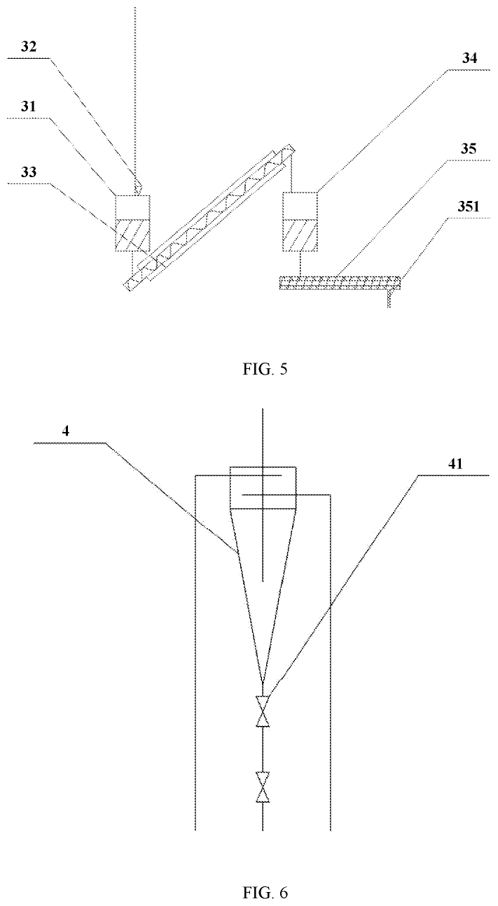

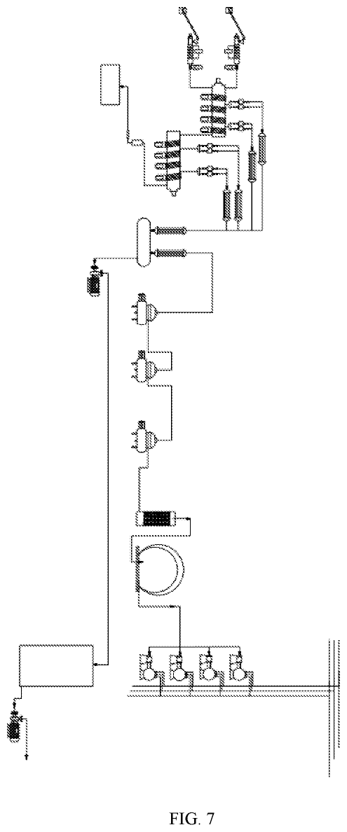

Referring to FIG. 1 to FIG. 7, some specific embodiments of the present disclosure employ the following technical solution: a novel process-based apparatus for pyrolysis of organic wastes, including: a feeding mechanism 1, a pyrolysis reaction mechanism 2, a carbon black slagging mechanism 3, a cyclone vacuum cleaner 4, a catalytic converter 5, a gas treatment mechanism 6, and a crude oil pump 7; wherein two said feeding mechanisms 1 are both connected to the pyrolysis reaction mechanism 2, the carbon black slagging mechanism 3 is connected to under a right end of the pyrolysis reaction mechanism 2 via a pipeline, the cyclone vacuum cleaner 4 is arranged at an upper end of the pyrolysis reaction mechanism 2, two said catalytic converters 5 are connected at a top end of the cyclone vacuum cleaner 4 via a pipeline, the gas treatment mechanism 6 is connected to a high end of the catalytic converter 5 via a pipeline, and the crude oil pump 7 is connected to a lower end of the gas treatment mechanism 6 via a pipeline.

The gas treatment mechanism 6 includes a first condenser 61, a crude oil tank 62, a second condenser 63, a flammable gas purifier 64, a fuel gas compressor 65, a dehydrator 66, a gas storage capsule 67, and a fuel gas generator set 68; wherein top ends of two reforming catalytic converters 5 are both connected to a top end of the first condenser 61, a bottom end of the first condenser 61 is connected to a top end of the crude oil tank 62, a plurality of said second condensers 63 are connected over the crude oil tank 62 via pipelines, the second condensers 63 are connected via a pipeline, a top end of the second condenser 63 is connected to the flammable gas purifier 64 via a pipeline, a right side of the flammable gas purifier 64 is connected to a top left side of the fuel gas compressor 65, a top right side of the fuel gas condenser 65 is connected to a left lower end of the dehydrator 66, a top end of the dehydrate 66 is connected to the gas storage capsule 67 via a pipeline, and a right side of the gas storage capsule 67 is connected to the fuel gas generator set 68 via a pipeline.

A second high-temperature seal valve 51 is arranged on all left pipelines and top pipelines of two reforming catalytic converters 5, and an electromagnetic heater 52 is arranged on both bottom ends of the two reforming catalytic converters 5.

The feeding mechanism 1 includes a belt conveyor 11, a feeder 12, a plastic extruder 13, and a plastic electromagnetic heater 14; wherein the feeder 12 is arranged under a right end of the belt conveyor 11, the feeder 12 is arranged over a left end of the plastic extruder 13, the plastic electromagnetic heater 14 is arranged on both a middle portion and a right end of the plastic extruder 13, and a right end of the plastic extruder 13 is connected to the reaction kettle 21 via a pipeline.

The pyrolysis reaction mechanism 2 includes a reaction kettle 21 and a reactor electromagnetic heater 22; wherein a plurality of said reactor electromagnetic heaters 22 are arranged on the reaction kettle 21, a top end of the reaction kettle 21 is connected to the cyclone vacuum cleaner 4 via three pipelines, and a bottom end of the reaction kettle 21 is connected to the carbon black slagging mechanism 3 via a pipeline.

Two oil and gas outlets 211 are arranged in a top end of the reaction kettle 21; wherein the oil and gas outlets 211 are connected to left and right sides of the cyclone vacuum cleaner 4 via pipelines, a bottom end of the cyclone vacuum cleaner 4 is connected to the top end of the reaction kettle 21 via a pipeline, and two first high-temperature seal valves 41 are arranged on a pipeline at the bottom end of the cyclone vacuum cleaner 4.

The carbon black slagging mechanism 3 includes a carbon black bin 31, a radar level gauge 32, a water-cooled screw conveyor 33, a carbon black storage bin 34, and a packing screw conveyor 35; wherein a top end of the carbon black bin 31 is connected to a right lower side of the reaction kettle 21, the radar level gauge 32 is arranged on a right side of a top pipeline of the carbon black bin 31, the water-cooled screw conveyor 33 is connected to a bottom end of the carbon black bin 31 via a pipeline, a right side of the water-cooled screw conveyor 33 is connected to a top end of the carbon black storage bin 34, a bottom end of the carbon black storage bin 34 is connected to a left end of the packing screw conveyor 35 via a pipeline, and an outlet 351 is arranged in a right lower side of the packing screw conveyor 35. The apparatus is a single reaction kettle system.

The apparatus according to the present disclosure operates by the following principles: The materials are fed by the belt conveyor 11 to the feeder 12 and pressed by the feeder 12 into the plastic extruder 13; the plastic extruder 13 is heated by the plastic electromagnetic heater 14 to a predetermined temperature, such that the materials are heated to the molten state and pressed into the reaction kettle 21. The reaction kettle 21 is heated by four reaction kettle electromagnetic heaters to a predetermined temperature for each section, and under a suitable temperature, the materials are immediately converted into oil and gas under stirring by the auger in the reaction kettle 21. The reaction kettle 21 is designed to have a diameter of 1600 mm and a length of 8500 mm, such that reactants are sufficiently reacted in the reaction kettle 21. The apparatus achieves a production amount as per day of a double-kettle system. An auger shaft, an auger and a reamer in the reaction kettle 21 are welded as an whole, such that the auger shaft is prevented from bending and deformation. For air tightness of the reaction kettle, flexible high-temperature grease shaft seals are applied to two ends of the auger shaft, a high-temperature seal valve is employed in a high-temperature oil and gas loop, and the carbon black discharging port employs isolation of the carbon black bin.

A large amount of oil and gas are discharged from the oil and gas outlet 211. The oil and gas may bring out some micro carbon black. The oil and gas enters the cyclone vacuum cleaner 4, and the carbon black is removed. The carbon black is passed through the high-temperature seal valves 41, and returns to the reaction kettle 21 through airtightness interlocking.

The oil and gas passed through the cyclone vacuum cleaner enters one of the two reforming catalytic converters 5, and one of the two catalytic converters is active while the other is in a standby state, such that it is convenient for replacement where any catalytic converter encounters a failure. Four high-temperature seal valves 51 isolate the two catalytic converters 5. Upon being modified by the reforming catalytic converts 5, most of the high-temperature oil and gas are converted into light oil and gas and flammable gas. Upon being condensed by the first condenser 61, light oil enters the crude oil tank 62, and flammable gas that is incondensable enters the flammable gas purifier 64. Upon desulfurization, dechlorination, and dust removal, the incondensable flammable gas is passed through the fuel gas compressor 65 and pressed into the dehydrator 66, and is then fed into the gas storage capsule 67 via a pipeline for the fuel gas generator set 68 to generate power. The crude oil in the crude oil tank 54 is conveyed for sale or refinement via the crude oil pump 7.

The materials in the reaction kettle 21 are mostly converted into oil and gas, and still a small amount of carbon black is constantly pushed backwards under stirring by the auger. When reaching the slagging port of the reaction kettle 21, reaction of the materials is completed, and the remaining carbon black is pushed by the auger into the carbon black bin 31. The level of the carbon black bin 31 is determined by the radar level gauge 32, and a specific level is maintained to ensure the airtightness of the reaction kettle 21. The carbon black exceeding the determined level is fed by the water-cooled screw conveyor 33 to the carbon black storage bin 34, and is then transported and packed by the packing screw conveyor 35 for sale.

The apparatus according to the present disclosure operates by the following principles: The materials are fed by the belt conveyor to the feeder and pressed by the feeder into the plastic extruder. The plastic extruder is heated by the plastic electromagnetic heater to a predetermined temperature, such that the materials are heated to the molten state and pressed into the reaction kettle. The reaction kettle is heated by four reaction kettle electromagnetic heaters to a predetermined temperature for each section, and under a suitable temperature, the materials are immediately transformed into oil and gas under stirring by the auger in the reaction kettle. A large amount of oil and gas are discharged from the oil and gas outlet. The oil and gas may bring out some micro carbon black. The oil and gas enter the cyclone vacuum cleaner, and the carbon black is removed. The carbon black is passed through the high-temperature seal valves, and returns to the reaction kettle through airtightness interlocking, such that the carbon back is removed from the oil and gas.

The carbon black in the reaction kettle is constantly pushed backwards with the stirring by the auger. When reaching the slagging port of the reaction kettle, reaction of the materials is completed, and the remaining carbon black is pushed by the auger into the carbon black bin. The level of the carbon black bin is determined by the radar level gauge, and a specific level is maintained to ensure the airtightness of the reaction kettle. The carbon black exceeding the determined level is fed by the water-cooled screw conveyor to the carbon black storage bin, and is then transported and packed by the packing screw conveyor for sale.

The oil and gas passed through the cyclone vacuum cleaner enters one of the two reforming catalytic converters, and one of the two catalytic converters is active while the other is in a standby state, such that it is convenient for replacement where any catalytic converter encounters a failure. Four high-temperature seal valves isolate the two catalytic converters. Upon being modified by the reforming catalytic converts, most of the high-temperature oil and gas are converted into light oil and gas and flammable gas. Upon being condensed by the condenser, light oil enters the crude oil tank, and flammable gas that is incondensable enters the flammable gas purifier. Upon desulfurization, dechlorination, and dust removal, the incondensable flammable gas is passed through the fuel gas compressor and pressed into the dehydrator, and is then fed into the gas storage capsule via a pipeline for the fuel gas generator set to generate power. The crude oil in the crude oil tank is conveyed for sale or refinement via the crude oil pump 7.

With the above technical solutions, the present disclosure achieves the following technical effects: The apparatus employs a single reaction kettle system, and implements continuous feeding, continuous pyrolysis, continuous discharging (crude oil, carbon black, and flammable incondensable gas), effective use of incondensable gas, and energy saving and emission reduction while fully utilizing inherited heat energy to achieve energy saving. The entire system operates under negative micro-pressure, and hazardous gas and dust are effectively controlled, such that generation of hazardous gas dioxin and leakage of dust are prevented, and production sites are maintained clean and tidy.

According to the specific embodiments of the present disclosure, based on the conventional apparatus, the double reaction kettle system is modified to a single reaction kettle system, which implements continuous feeding, continuous pyrolysis, continuous discharging, and effective use of incondensable gas. The entire system operates under negative micro-pressure, and hazardous gas and dust are effectively controlled, such that generation of hazardous gas dioxin and leakage of dust are prevented, and production sites are maintained clean and tidy.

It should be finally noted that the embodiments are merely for illustration of the present disclosure, but are not intended to limit the present disclosure. Although the present disclosure is described in detail with reference to these embodiments, a person skilled in the art may also make various modifications to the technical solutions disclosed in the embodiments, or make equivalent replacements to a part of or all technical features contained therein. Such modifications or replacement, made without departing from the principles of the present application, shall fall within the scope defined by the claims and the specification of the present application.

1. An apparatus for pyrolysis of organic wastes, comprising:
a feeding mechanism (1), a pyrolysis reaction mechanism (2), a carbon black slagging mechanism (3), a cyclone vacuum cleaner (4), a catalytic converter (5), a gas treatment mechanism (6), and a crude oil pump (7);
wherein two said feeding mechanisms (1) are both connected to the pyrolysis reaction mechanism (2), the carbon black slagging mechanism (3) is connected to under a right end of the pyrolysis reaction mechanism (2) via a pipeline, the cyclone vacuum cleaner (4) is arranged at an upper end of the pyrolysis reaction mechanism (2), two said catalytic converters (5) are connected at a top end of the cyclone vacuum cleaner (4) via a pipeline, the gas treatment mechanism (6) is connected to a high end of the catalytic converter (5) via a pipeline, and the crude oil pump (7) is connected to a lower end of the gas treatment mechanism (6) via a pipeline.

2. The apparatus for pyrolysis of organic wastes according to claim 1, wherein the gas treatment mechanism (6) comprises a first condenser (61), a crude oil tank (62), a second condenser (63), a flammable gas purifier (64), a fuel gas compressor (65), a dehydrator (66), a gas storage capsule (67), and a fuel gas generator set (68);
wherein top ends of two reforming catalytic converters (5) are both connected to a top end of the first condenser (61), a bottom end of the first condenser (61) is connected to a top end of the crude oil tank (62), a plurality of said second condensers (63) are connected over the crude oil tank (62) via pipelines, the second condensers (63) are connected via a pipeline, a top end of the second condenser (63) is connected to the flammable gas purifier (64) via a pipeline, a right side of the flammable gas purifier (64) is connected to a top left side of the fuel gas compressor (65), a top right side of the fuel gas condenser (65) is connected to a left lower end of the dehydrator (66), a top end of the dehydrate (66) is connected to the gas storage capsule (67) via a pipeline, and a right side of the gas storage capsule (67) is connected to the fuel gas generator set (68) via a pipeline.

3. The apparatus for pyrolysis of organic wastes according to claim 1, wherein a second high-temperature seal valve (51) is arranged on all left pipelines and top pipelines of two reforming catalytic converters (5), and an electromagnetic heater (52) is arranged on both bottom ends of the two reforming catalytic converters (5).

4. The apparatus for pyrolysis of organic wastes according to claim 1, wherein the feeding mechanism (1) comprises a belt conveyor (11), a feeder (12), a plastic extruder (13), and a plastic electromagnetic heater (14);
wherein the feeder (12) is arranged under a right end of the belt conveyor (11), the feeder (12) is arranged over a left end of the plastic extruder (13), the plastic electromagnetic heater (14) is arranged on both a middle portion and a right end of the plastic extruder (13), and a right end of the plastic extruder (13) is connected to the reaction kettle (21) via a pipeline.

5. The apparatus for pyrolysis of organic wastes according to claim 1, wherein the pyrolysis reaction mechanism (2) comprises a reaction kettle (21) and a reactor electromagnetic heater (22);
wherein a plurality of said reactor electromagnetic heaters (22) are arranged on the reactor (21), a top end of the reaction kettle (21) is connected to the cyclone vacuum cleaner (4) via three pipelines, and a bottom end of the reaction kettle (21) is connected to the carbon black slagging mechanism (3) via a pipeline.

6. The apparatus for pyrolysis of organic wastes according to claim 5, wherein two oil and gas outlets (211) are arranged in a top end of the reaction kettle (21);
wherein the oil and gas outlets (211) are connected to left and right sides of the cyclone vacuum cleaner (4) via pipelines, a bottom end of the cyclone vacuum cleaner (4) is connected to the top end of the reaction kettle (21) via a pipeline, and two first high-temperature seal valves (41) are arranged on a pipeline at a bottom end of the cyclone vacuum cleaner (4).

7. The apparatus for pyrolysis of organic wastes according to claim 1, wherein the carbon black slagging mechanism (3) comprises a carbon black bin (31), a radar level gauge (32), a water-cooled screw conveyor (33), a carbon black storage bin (34), and a packing screw conveyor (35);
wherein a top end of the carbon black bin (31) is connected to a right lower side of the reaction kettle (21), the radar level gauge (32) is arranged on a right side of a top pipeline of the carbon black bin (31), the water-cooled screw conveyor (33) is connected to a bottom end of the carbon black bin (31) via a pipeline, a right side of the water-cooled screw conveyor (33) is connected to a top end of the carbon black storage bin (34), a bottom end of the carbon black storage bin (34) is connected to a left end of the packing screw conveyor (35) via a pipeline, and an outlet (351) is arranged in a right lower side of the packing screw conveyor (35).

8. The apparatus for pyrolysis of organic wastes according to claim 1, wherein the apparatus is a single reaction kettle system.
